(19) United States
(12) Patent Application Publication
(10) Pub. No.: US 2024/0399362 A1
(43) Pub. Date: Dec. 5, 2024

(54) Methods, Devices and Systems for Generating a Chemical Gradient

(71) Applicants: Emory University, Atlanta, GA (US); Children's Healthcare of Atlanta, Inc., Atlanta, GA (US)

(72) Inventors: Tobey John MacDonald, Decatur, GA (US); Anna Maria Kenney, Atlanta, GA (US); Abhinav Dey, Decatur, GA (US); YongTae Kim, Suwanee, GA (US)

(21) Appl. No.: 18/273,973

(22) PCT Filed: Jan. 21, 2022
(86) PCT No.: PCT/US2022/013307

§ 371 Date: Jul. 24, 2023

Related U.S. Application Data
(60) Provisional application No. 63/140,632, filed on Jan. 22, 2021.

(51) Int. Cl. B01L 3/00

(52) U.S. Cl. CPC B01L 3/502715; B01L 2200/0694; B01L 2300/0829; B01L 2300/087; B01L 2300/0883

(57) ABSTRACT

The systems, devices, and methods utilize devices configured to generate multiple gradients of a plurality of different drugs in x and y coordinates at the same time so as to provide multiple drug concentrations and/or combinations. A device may include a first layer having a first set of one or more inlets in fluid communication with stem channels and a plurality of chambers, and a second layer having a second set of one or more inlets in fluid communication with stem channels and a plurality of chambers. The second layer may be disposed above the first layer so that the first set and the second set of inlets are offset and the plurality of chambers of the first and second layers align and overlap. The device may include a plurality of wells defined by the aligned the plurality of chambers of the first layer and the second layer.

### CROSS-REFERENCE TO RELATED APPLICATIONS

This application claims the benefit of U.S. Provisional Application No. 63/140,632 filed Jan. 22, 2021. The entirety of this application is hereby incorporated by reference for all purposes.

### BACKGROUND

Current methods for identifying novel drugs and drug combinations, for example, for tumor-targeting combination therapies, for clinical investigation, generally rely on in vitro screens and in vivo mouse models, such as genetically-engineered models (GEMs) or patient-derived xenografts (PDXs). The in vitro models can critically lack an intact microenvironment, such as an intact brain tumor microenvironment. The in vivo models can be limited by the inability to rapidly and clearly monitor the molecular and cellular tumor responses to the agents tested in real-time. Furthermore, PDXs and GEMS can typically take months to evaluate, can be susceptible to genetic change over time, and can be time and labor intensive. These deficiencies have severely hindered the rapid identification of promising new agents and the development of clinical approaches that integrate effective multi-drug combination therapies, for example, to treat cancer patients.

### SUMMARY

Thus, there is need for more efficient systems, devices and methods that can rapidly identify and validate effective new combination therapies for clinical investigation. These devices and methods can be used for drug discovery, personalized medicine, among others, or a combination thereof.

In some embodiments, the devices may include a microfluidic device that includes two or more layers. In some embodiments, the device may include a first layer having a first set of one or more inlets in fluid communication with stem channels and a plurality of chambers. The device may include a second layer having a second set of one or more inlets in fluid communication with stem channels and a plurality of chambers. The second layer may be disposed above the first layer so that the first set of inlets and the second set of inlets are offset and the plurality of chambers of the first layer and the second layer align and overlap. The device may include a plurality of wells defined by the aligned the plurality of chambers of the first layer and the plurality of chambers of the second layer. Each stem channel of the first layer and the second layer may include a plurality of branch channels in direct fluid communication with each well. Each branch channel of each layer is in direct fluid communication with a chamber of the each layer. Each branch channel may be disposed at an angle with respect to a respective stem channel and a respective chamber of the respective layer. Each well may be in direct fluid communication with a respective branch channel of the first layer and a respective branch channel of the second layer.

Additional advantages of the disclosure will be set forth in part in the description which follows, and in part will be obvious from the description, or may be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### BRIEF DESCRIPTION OF THE DRAWINGS

The disclosure can be better understood with the reference to the following drawings and description. The components in the figures are not necessarily to scale, emphasis being placed upon illustrating the principles of the disclosure.

FIG. 1A shows a top view of a device according to some embodiments;

FIG. 1B shows an enlarged, partial view of the device of FIG. 1A;

FIG. 2A shows the layers of the device of FIG. 1A;

FIG. 2B shows the relationship of the branch channels of each layer shown in FIG. 2A;

FIG. 2C shows an enlarged partial view of a layer shown in FIG. 2A;

FIG. 3A shows an exploded view of the device shown in FIG. 1A;

FIG. 3B shows an exploded side view shown in FIG. 3A;

FIG. 4A shows a cross-sectional view of the device of FIG. 1A;

FIG. 4B shows an enlarged cross-sectional view of FIG. 4A;

FIG. 5A shows an example of the device shown in FIG. 1A in which four different agents have been perfused according to embodiments;

FIG. 5B shows a view of a first layer shown in FIG. 5A; and

FIG. 5C shows a view of a second layer shown in FIG. 5A.

### DESCRIPTION OF THE EMBODIMENTS

In the following description, numerous specific details are set forth such as examples of specific components, devices, methods, etc., in order to provide a thorough understanding of embodiments of the disclosure. It will be apparent, however, to one skilled in the art that these specific details need not be employed to practice embodiments of the disclosure. In other instances, well-known materials or methods have not been described in detail in order to avoid unnecessarily obscuring embodiments of the disclosure. While the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

The systems, methods, and devices according to the disclosure relate to a high, throughput, microfluidic device that integrates a tissue culture with a high-precision chemical gradient generator. The chemical gradient generator can reliably administer selected drug combinations into a culture-media laden bottom well for controlled diffusion into a sample disposed therein. The devices according to the disclosure can generate multiple gradients of a plurality of different drugs in x and y coordinates at the same time so as to provide multiple drug concentrations and/or combinations, enabling a single-step selection of a drug cocktail (e.g., combination and dosage) for the plurality of different drugs in a single microfluidic device. The systems, methods, and devices according to the disclosure can be used for preclinical drug delivery studies, as well as personalized medicine. For example, the devices according to the disclosure can result in rapid and reliable prediction, in real-time, of possible drug combinations and/or dosages for treatment, for example, of cancers (e.g., brain tumors).

As used herein, the term “communicate” or “connect” (e.g., a first component “communicates with” or “is in communication with” a second component) or “fluid communication” and grammatical variations thereof are used herein to indicate a fluidic relationship between two or more components, channels and/or channel segments. As such, the fact that one component/channel/channel segment is said to communicate with a second component/channel/channel segment is not intended to exclude the possibility that additional components may be present between, and/or operatively associated or engaged with, the first and second components.

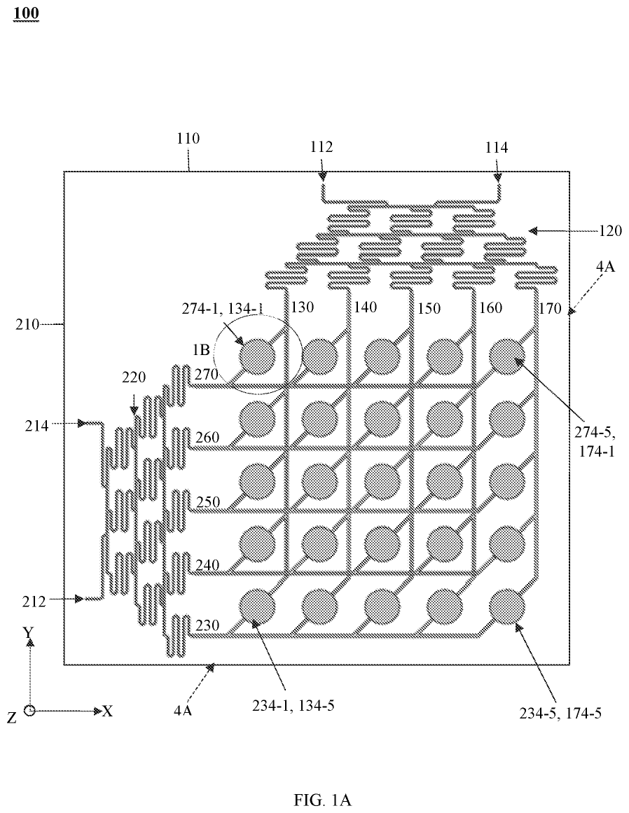

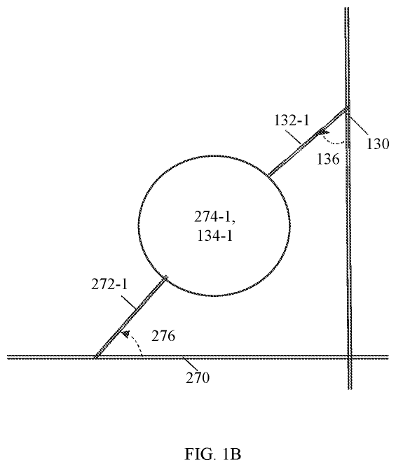

FIGS. 1A-5C show examples of a microfluidic device 100 according to embodiments. The device shown in the figures can generate five gradients of up to four different agents (e.g., drugs) in x and y coordinates so as to provide twenty-five combinations in each device. It will be understood that the device may be scaled up to screen additional agents (e.g., by including additional layers and/or inlets and/or inlet channels, etc.) so as to provide additional concentrations and/or combinations, as well as be reduced for less concentrations and/or combinations.

In some embodiments, each agent may be any chemical (e.g., a chemical compound, drug, toxin, growth factor, hormone, etc.), such as a therapeutic capable of perfusing through a tissue or cell sample. For example, the agents may include small molecule compounds; anti-cancer agent, such as chemotherapeutic agent and/or an immunomodulatory agent; biologics, such as T-cells, antibodies, etc.; “conventional” drugs; nucleic acid molecule, for example, a DNA molecule, an RNA molecule, or a DNA/RNA hybrid molecule, single-stranded, or double-stranded; RNAi agent, for example, an antisense-RNA, an siRNA, an shRNA, a snoRNA, a microRNA (miRNA), or a small temporal RNA (stRNA); an aptamer; a protein or peptide; an antibody or an antigen-binding antibody fragment; ligand- or receptor-binding protein; a gene therapy vector; among others; or any combinations and/or titrations thereof.

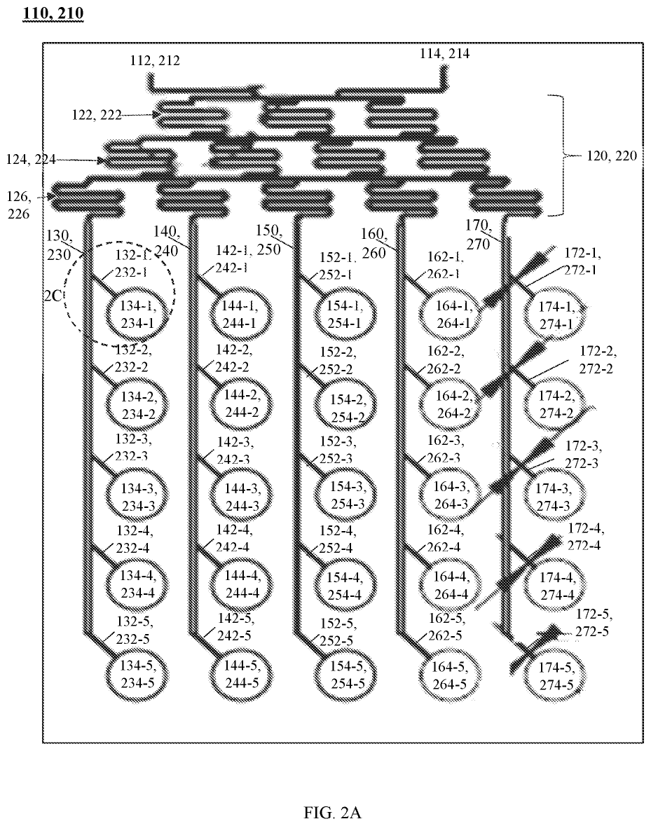

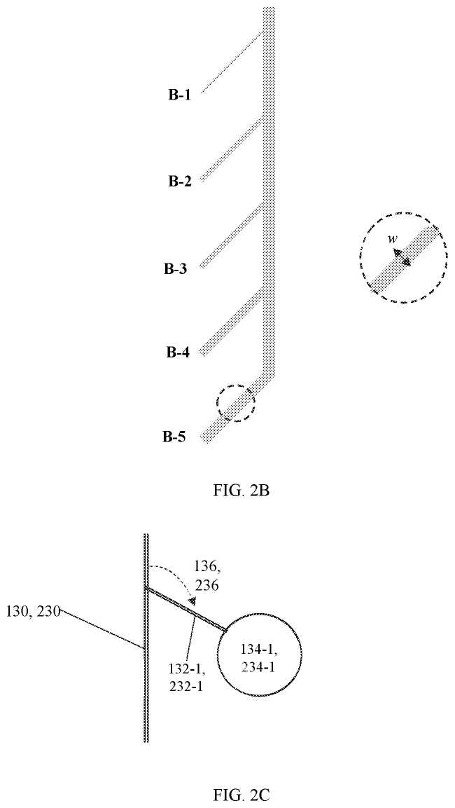

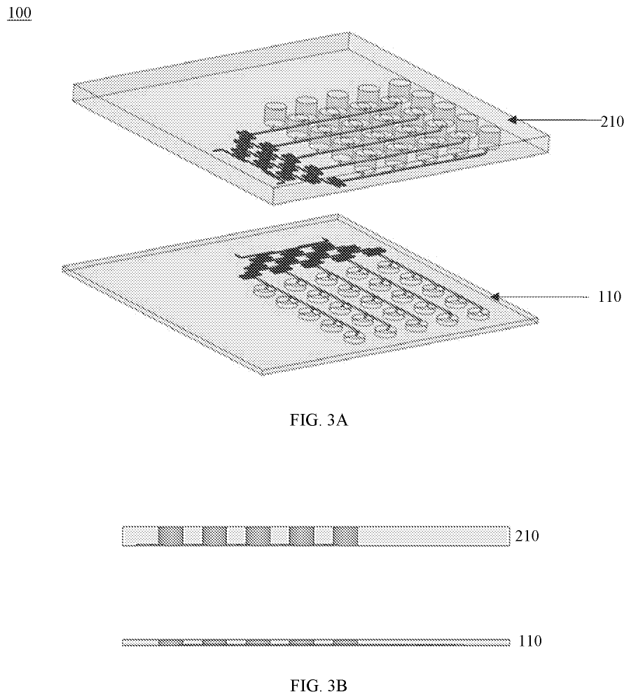

In some embodiments, the device may be a multi-layer device. In this example, as shown in FIGS. 1 and 3A-C, the device 100 may include a first layer 110 and a second layer 210 disposed above the first layer 110. In this example, the first layer 110 and the second layer 210 may have the same configuration of channels and chambers as shown in FIGS. 2A-C.

FIGS. 2A-C show a top view of each layer (i.e., the layer 110 or the layer 210) of the device 100. In some, each layer 110, 210 may include a set of at least one inlet. For example, each layer 110, 210 may include a set of two inlets 112, 114 and 212, 214, respectively. In some examples, each inlet 112, 212, 114, and 214 may be for a different agent.

In some embodiments, the inlets of the respective layer may be in fluid communication with a network of inlet channels that is in fluid communication with respective stem channels. In some embodiments, each network of inlet channels may include a plurality of generations of inlet channels so as to provide a different concentration of the agents to the stem channels of that layer. In this example, the network of inlet channels for each layer may include three generations of inlet channels so as to provide five different concentrations of the agents provided by the respective inlets of the layer to the stem channels. In some embodiments, each generation may be a series of serpentine (or zig-zag) channels as shown in the figures.

For example, for each layer 110/210, the first inlet 112/212 and the second inlet 114/214 may be in fluid communication with a network 120/220 of inlet channels. In this example, the network 120/220 may include a first generation 122/222 of inlet channels, a second generation 124/224 of inlet channels, and a third generation 126/226 of inlet channels. In some embodiments, the first generation 122/222 of inlet channels may include a series of three inlet channels. A first inlet channel of the first generation 122/222 may be in fluid communication with only the first inlet 112/212, a second (i.e., the middle) inlet channel of the first generation 122/222 may be in fluid communication with the first inlet 112/212 and the second inlet 114/214, and a third inlet channel of the first generation 122/222 may be in fluid communication with only the second inlet 114/214.

In some embodiments, the second generation 124/224 of inlet channels may include a series of four inlet channels that are in fluid communication with the first generation 122/222 and the third generation 126/226. A first inlet channel of the second generation 124/224 may be in fluid communication with only the first inlet 112/212 via the first inlet channel of the first generation 122/222; a second inlet channel and a third inlet channel of the second generation 124/224 may be in fluid communication with the first inlet 112/212 and the second inlet 114/214 via the first generation 122/222; and a fourth inlet of the second generation 124/224 may be in fluid communication with only the second inlet 114/214 via the third inlet channel of the first generation 122/222. The second inlet channel of the second generation 124/224 may be in fluid communication with the first inlet channel and the second inlet channel of the first generation 122/222; and the third inlet channel of the second generation 124/224 may be in fluid communication with the second inlet channel and the third inlet channel of the first generation 122/222. This way, the second inlet channel and the third inlet channel of the second generation 124/224 may have different concentrations of the agents provided in the first inlet 112/212 and the second inlet 114/214.

In some embodiments, the third generation 126/226 of inlet channels may include a series of five inlet channels that are in fluid communication with the second generation 124/224 and respective stem channel. A first inlet channel of the third generation 126/226 may be in fluid communication with only the first inlet 112/212 via the first inlet channel of the second generation 124/224; a second inlet channel, a third inlet channel, and a fourth inlet channel of the third generation 126/226 may be in fluid communication with the first inlet 112/212 and the second inlet 114/214 via the second and third inlet channels of the second generation 124/224; and a fifth inlet channel of the third generation 126/226 may be in fluid communication with only the second inlet 114/214 via the fourth inlet channel of the second generation 124/224. The second inlet channel of the third generation 126/226 may be in fluid communication with the first inlet channel and the second inlet channel of the second generation 124/224; the third inlet channel of the third generation 126/226 may be in fluid communication with the second inlet channel and the third inlet channel of the second generation 124/224; and the fourth inlet channel of the third generation 126/226 may be in fluid communication with the third inlet channel and the fourth inlet channel of the second generation 124/224. This way, the second inlet channel, the third inlet channel, and the fourth inlet channel of the third generation 126/226 may have different concentrations of the agents provided via the first inlet 112/212 and the second inlet 114/214.

As shown, each inlet channel of the third generation 126/226 may be in fluid communication with a stem channel. In this example, each layer 110/210 may include five stem channels. The respective network 120/220 of inlet channels can be configured to provide five different concentrations of two agents provided in the respective inlets 112/212 and 114/214 to the five stem channels. It will be understood that each layer may include more or less stem channels (e.g., three stem channels, four stem channels, six stem channels, seven stem channels, more than seven stem channels, etc.). The configuration (e.g., number of generations, number of inlet channels, etc.) of the respective network 120/220 of the inlet channels may correspond to the respective number of the stem channels of that layer.

As shown in the FIGS. 1A and 2A, each layer 110/210 may include a first stem channel 130/230, a second stem channel 140/240, a third stem channel 150/250, a fourth stem channel 160/260, and a fifth stem channel 170/270. In some embodiments, each stem channel may have a plurality of branch channels that extend therefrom and that is in fluid communication with a chamber. Each of the branch channels, disposed between a respective stem channel and chamber, may be configured to provide a different concentration of one or more agents to the respective chamber.

For example, for the layer 110, the first stem channel 130 may include a first branch channel 132-1 that may be in fluid communication with a first chamber 134-1; a second branch channel 132-2 that communicates with a second chamber 134-2; a third branch channel 132-3 that communicates with a third chamber 134-3; a fourth branch channel 132-4 that communicates with a fourth chamber 134-4; and a fifth branch channel 132-5 that communicates with chamber 134-5. The second stem channel 140 may include a first branch channel 142-1 that communicates with a first chamber 144-1; a second branch channel 142-2 that communicates with a second chamber 144-2; a third branch channel 142-3 that communicates with a third chamber 144-3; a fourth branch channel 142-4 that communicates with a fourth chamber 144-4; and a fifth branch channel 142-5 that communicates with chamber 144-5. The third stem channel 150 may include a first branch channel 152-1 that communicates with a first chamber 154-1; a second branch channel 152-2 that communicates with a second chamber 154-2; a third branch channel 152-3 that communicates with a third chamber 154-3; a fourth branch channel 152-4 that communicates with a fourth chamber 154-4; and a fifth branch channel 152-5 that communicates with chamber 154-5. The fourth stem channel 160 may include a first branch channel 162-1 that communicates with a first chamber 164-1; a second branch channel 162-2 that communicates with a second chamber 164-2; a third branch channel 162-3 that communicates with a third chamber 164-3; a fourth branch channel 162-4 that communicates with a fourth chamber 164-4; and a fifth branch channel 162-5 that communicates with chamber 164-5. The fifth stem channel 170 may include a first branch channel 172-1 that communicates with a first chamber 174-1; a second branch channel 172-2 that communicates with a second chamber 174-2; a third branch channel 172-3 that communicates with a third chamber 174-3; a fourth branch channel 172-4 that communicates with a fourth chamber 174-4; and a fifth branch channel 172-5 that communicates with chamber 174-5.

For example, for the second layer 210, the first stem channel 230 may include a first branch channel 232-1 that communicates with a first chamber 234-1; a second branch channel 232-2 that communicates with a second chamber 234-2; a third branch channel 232-3 that communicates with a third chamber 234-3; a fourth branch channel 232-4 that communicates with a fourth chamber 234-4; and a fifth branch channel 232-5 that communicates with chamber 234-5. The second stem channel 240 may include a first branch channel 242-1 that communicates with a first chamber 244-1; a second branch channel 242-2 that communicates with a second chamber 244-2; a third branch channel 242-3 that communicates with a third chamber 244-3; a fourth branch channel 242-4 that communicates with a fourth chamber 244-4; and a fifth branch channel 242-5 that communicates with chamber 244-5. The third stem channel 250 may include a first branch channel 252-1 that communicates with a first chamber 254-1; a second branch channel 252-2 that communicates with a second chamber 254-2; a third branch channel 252-3 that communicates with a third chamber 254-3; a fourth branch channel 252-4 that communicates with a fourth chamber 254-4; and a fifth branch channel 252-5 that communicates with chamber 254-5. The fourth stem channel 260 may include a first branch channel 262-1 that communicates with a first chamber 264-1; a second branch channel 262-2 that communicates with a second chamber 264-2; a third branch channel 262-3 that communicates with a third chamber 264-3; a fourth branch channel 262-4 that communicates with a fourth chamber 264-4; and a fifth branch channel 262-5 that communicates with chamber 264-5. The fifth stem channel 270 may include a first branch channel 272-1 that communicates with a first chamber 274-1; a second branch channel 272-2 that communicates with a second chamber 274-2; a third branch channel 272-3 that communicates with a third chamber 274-3; a fourth branch channel 272-4 that communicates with a fourth chamber 274-4; and a fifth branch channel 272-5 that communicates with chamber 274-5.

In some embodiment, the dimensions (e.g., weight, height, and length) of the stem channels may be the same for each layer. For example, each stem channel may have a width of about 0.25 mm and a height of about 0.25 mm.

In some embodiments, for each respective stem channel, the dimensions of the branch channels may be different so that each branch channel can be configured to supply a different concentration of the one or more agents provided by the respective stem channel to the respective chamber. In some embodiments, the height and length of the branch channels of a respective stem channel may be the same. For example, each branch channel may have a height of about 0.25 mm. In some embodiments, the width of the branch channels may be different for the respective stem channel. For example, the widths of the branch channels may range from about 0.05-0.24.

For example, as shown in FIG. 2B, for each stem channel, the first branch channel B-1, which is the branch channel located at near a first end of the stem channel closest to the respective network of inlet channels, may have a width w1; the second branch channel B-2 may have a width w2; the third branch channel B-3 may have a width w3; the fourth branch channel B-4 may have a width w4; and the fifth branch channel B-5, which is the branch channel located at opposite, second end of the stem channel, may have a width w5. The relationship of the width dimensions may be as follows: w1<w2<w3<w4<w5. This way, each stem channel can screen five different concentrations of the respective agent(s) in its respective chambers. In this example, the first branch channel B-1 of the respective stem channel of each layer may be configured to provide a smallest concentration of the respective agent(s) to its respective chamber and the fifth branch channel B-5 may be configured to provide a largest concentration of the respective agent(s) provided in that stem channel to its respective chamber. These different widths can provide different fluidic resistances and thus different pressure drops downstream, providing the same delivery conditions (e.g., flow rate) to each chamber/well. For example, the channel dimensions may be configured so that each inlet may have a flow rate of about 50 ul/min by gravity.

By way of example, the width (w1) of the first branch channel B-1 may be about 0.09 mm, the width (w2) of the second branch channel B-2 may be about 0.11 mm; the width (w3) of the third branch channel B-3 may be about 0.13 mm; the width (w4) of the fourth branch channel B-4 may be about 0.17 mm; and the width (w5) of the fifth branch channel B-5 may be about 0.22 mm. The widths of the branch channels are not limited to these dimensions and may be different. In some embodiments, the largest width w5 may be smaller than the width of the respective stem channel.

In some embodiments, each branch channel may be disposed at angle with respect to the respective stem channel. For example, as shown in FIG. 2C, for the stem channel 130, 230, the respective branch channel 132-1, 232-1 may be disposed at an angle 136, 236 with respect to the stem channel 130. In some embodiments, the angle 136, 236 may be about 30-60 degrees. For example, the angle 136, 236 may be about 45 degrees as shown in the figures. The angle for each branch channel of each layer may be the same.

In some embodiments, the diameter of each well/chamber of each layer may be about the same size. For example, the diameter may be about 1 mm to about 10 mm. The size of the chamber may correspond to the culture to be analyzed in the chambers. For example, the culture may include but is not limited to a cell sample, a tissue sample, such as a tissue core biopsy or a tissue slice. For example, the tissue sample can be taken from a tumor and/or healthy tissue. By way of example, each well/chambers may have a diameter so that it can be configured to accommodate a tissue sample of about 5 mm or smaller.

As shown in FIG. 1A, the second layer 210 may be stacked on the first layer 110. The second layer 210 may be positioned so that 1) the inlets 212, 214 is perpendicular (offset about 90 degrees) to the inlets 112, 114 of the first layer 110; and 2) that the chambers of the respective layers align/overlap/intersect so as to form a plurality of respective wells. As shown in FIG. 1A, each formed well may be in fluid communication with a branch channel of the first layer and a branch channel of the second layer. In this example, twenty-five different concentrations and combinations of four different agents (supplied via one of the inlets) may be screened with respect to a sample. It will be understood that the device may be configured to test more or less concentrations and/or combinations of agents by scaling up and/or down the device.

For example, as shown in FIG. 1B, the well formed by the chambers 274-1 and 134-1 may be in fluid communication with the first branch channel 272-1 of the fifth stem channel 270 of the second layer 210 and with the first branch channel 132-1 of the first stem channel 130 of the first layer 110. In this example, in use, a sample disposed in that well would be supplied a concentration of an agent from the second inlet 214 and a concentration of an agent from the first inlet 112.

As shown in FIG. 1B, the branch channel 272-1 and the branch channel 132-1 may be disposed at an angle 276, 136 with respect to the fifth stem channel 270 of the second layer 210 and the first stem channel 130 of the first layer 110, respectively. The angle 276 and 136 may be the same. In this example, the angle 276, 136 may be about 45 degrees. It would be understood that the angle 276, 136 may be different. For example, the angle 276, 136 may be about 30-60 degrees.

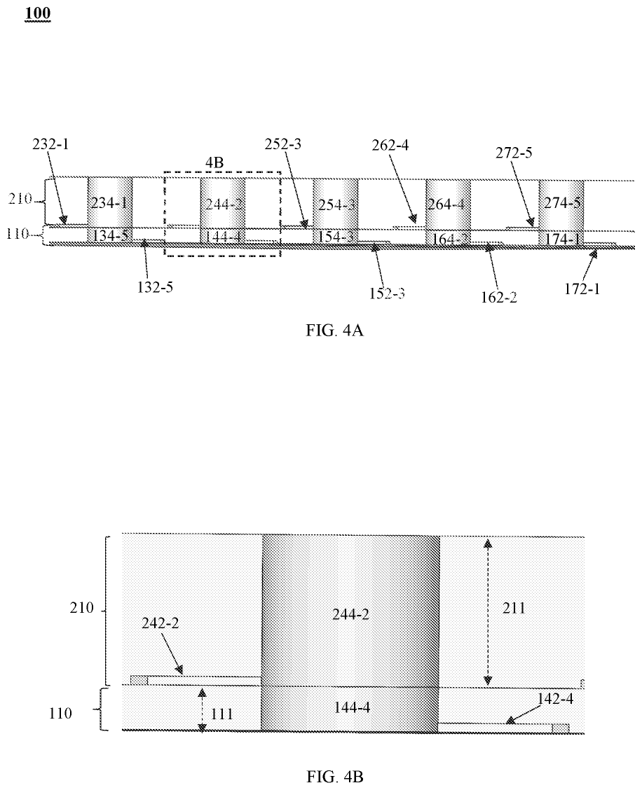

FIG. 3A-4B show additional views of the device 100. FIGS. 3A and 3B show exploded views of the device 100. As shown in these figures, the second layer 210 may have an overall height (z direction) 211 that is larger than an overall height 111 of the first layer 110. As shown, the layers may be disposed so that the respective inlets are perpendicular (i.e., offset by about 90 degrees) and the chambers are aligned so as to form wells for the sample to be analyzed. In use, the second layer 210 may be exposed so as to provide access to the wells formed by the chambers. The channels of the first and second layers may be closed. The channels of the first and second layers may be formed within each layer, for example, at the bottom of each layer.

FIGS. 4A and 4B show partial, enlarged cross-sectional views of the device 100 shown in FIG. 1. As shown, the well formed by the aligned/intersected chambers of each layer can be in direct fluid communication with the respective branch from each layer. The channels of the channel layer 210 may not be in direct fluid communication with the channels of the first layer 110 and the fluid communication between the layers may occur only at the wells formed by the respective chambers.

For example, as shown in FIG. 4B, the well formed by the chambers 244-2 and 144-4 can be in direct fluid communication with the branch channel 242-2 and the branch channel 142-4. As shown in this figure, the layer 210 may have a height 211 and the layer 110 may have a height of 111. In this example, the channels (e.g., inlet, branch and stem channels) of each layer may have the same height 0.25 mm and the height of the layers 110 and 210 may be different. For example, the height 211 of the second layer 210 may be taller than the height 111 of the first layer 110. The height of each chamber may correspond to the height of the respective layer. By way of example, the height 211 of the layer 210 and the chamber 244-2 may be 4.25 mm, and the height 111 of the layer 110 and the chamber 144-4 may be 1.25 mm.

In use, a sample (e.g., tissue sample) to be analyzed with respect to four different agents may be disposed in the well on the top of the second layer 210. The location of each branch channel with respect to each well can enable diffusive mixing through the cells, delivering fully mixed chemicals to the sample to be analyzed in that well.

The dimensions of the device (e.g., heights and widths) may be different from those described herein. For example, the dimensions may depend on the sample to be analyzed, the number of agents, among others, or a combination thereof. For example, the heights of the layers and/or diameter of the chamber may depend on the sample to be analyzed.

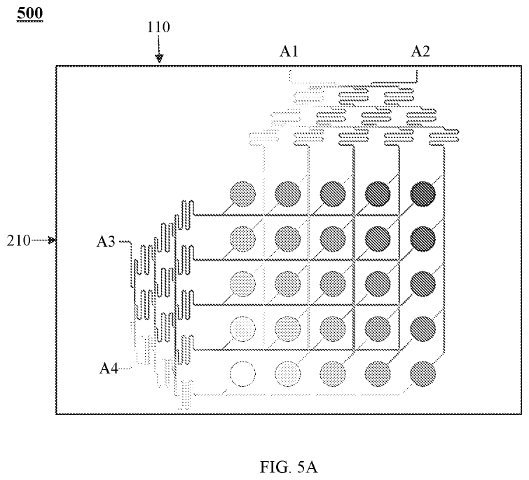

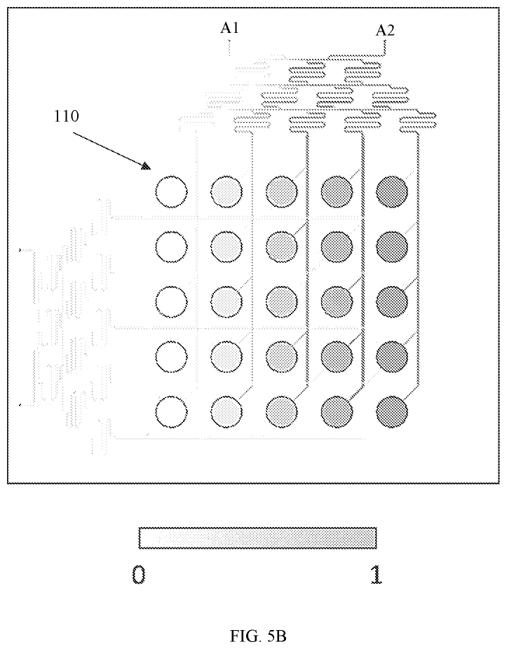

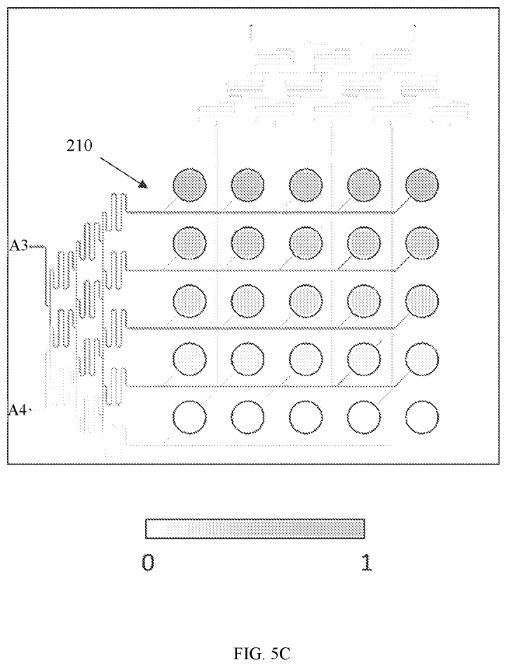

FIGS. 5A-C show an example 500 of the device 100 being used to screen four different agents with respect to a sample resulting in the screening of 25 different concentrations and combinations of the four different agents. Before adding the agents, a sample (e.g., a brain tissue sample with culture media) may be provided in each well formed by the chambers.

After the sample is provided in each well, the agents may be provided to the device 100. For example, each agent (e.g., can be provided in a media (e.g., control media)) can be provided/perfused through the device 100 via the respective inlet. For example, each agent (and media) may be delivered into the wells via the inlets using a perfusion pump (e.g., syringe with agent media and syringe pump). In some examples, each agent (and media) may be delivered into the wells using other means, such as, gravity (e.g., pipette), among others, or a combination thereof. In the example 500 shown in FIG. 5A, a first agent A1 can be perfused via the first inlet 112 and a second agent A2 can be perfused via the second inlet 114 of the first layer 110; a third agent A3 can be perfused via the first inlet 212 and a fourth agent A4 can be perfused via the second inlet 214 of the second layer 210. After the samples are perfused according to protocols, the samples may be analyzed with respect to the different concentrations and combinations of the agents.

FIG. 5A shows the resulting twenty-five different concentrations and combinations of the agents A1, A2, A3, and A4 perfused through the device 100 via the respective inlets. As shown in the example 500 of FIG. 5A, the twenty five different concentrations and combinations include: a combination/concentration of agents A1 and A4; three different concentrations of A1, A2, and A3; three different combinations of A1, A2, and A4; three different concentrations of A1, A3, and A4; a combination/concentration of A1 and A3; three different concentrations of A2, A3, and A4; a concentration/combination of A2 and A4; a concentration/combination of A2 and A3; and nine different concentrations of A1, A2, A3, and A4.

FIGS. 5B and 5C show the twenty-five different concentrations of the respective two agents resulting in the individual layers 110 and 210, respectively, that combine to achieve the twenty-five different concentrations and combinations of the four agents in the device 100 shown in FIG. 5A. As shown in FIG. 5B, the first layer 110, may have the following twenty-five concentrations and combinations of A1 and A2: five concentrations of agent A1; fifteen different concentrations of A1 and A2; and five concentrations of A2. As shown in FIG. 5C, the second layer 210, may have the following twenty-five concentrations and combinations of A3 and A4: five concentrations of agent A3; fifteen different concentrations of A3 and A4; and five concentrations of A4.

In some embodiments, the devices may be made of any material, including but not limited to, fluorinated ethylene propylene (FEP), polymethyl methacrylate (PMMA), cyclic olefin polymer (COP), cyclic olefin copolymer (COC), UV curable resins (such as glass (e.g., Pyrex), silicon and polymers (e.g., polydimethylsiloxane (PDMS), polystyrene (PS), polycarbonate (PC) or polyvinyl chloride (PVC)), other gas permeable/liquid impermeable materials, among others, or any combination thereof.

In some embodiments, the layers of the devices can be laminated together with or without adhesives to form the devices shown and described in the figures using any known technology. For example, the layers of the device can also be held together using thread forming screws, nuts and bolts, clips, clamps, pins, alignment holes/pegs, ultrasonic welding, solvent-assisted bonding, heat staking, thermal bonding, laser welding, snap fits, glue (e.g., biocompatible, low absorption adhesives such as acrylates) and/or surface treatment (e.g., oxygen plasma). During the assembly, a microscope or other machinery can be used to assist with the alignment of the components. In some embodiments, the one or more layers may be clear so as to allow for imaging studies.

By way of example, one or more of the layers may include a biocompatible material (e.g., FEP) having adhesive on each side so that it may be disposed between two substrates, such as PDMS slabs, other FEP sheets, or a combination thereof.

While the disclosure has been described in detail with reference to exemplary embodiments, those skilled in the art will appreciate that various modifications and substitutions may be made thereto without departing from the spirit and scope of the disclosure as set forth in the appended claims. For example, elements and/or features of different exemplary embodiments may be combined with each other and/or substituted for each other within the scope of this disclosure and appended claims.

1. A microfluidic device comprising:
a first layer having a first set of one or more inlets in fluid communication with stem channels and a plurality of chambers;
a second layer having a second set of one or more inlets in fluid communication with stem channels and a plurality of chambers;
the second layer being disposed above the first layer so that the first set of inlets and the second set of inlets are offset, and the plurality of chambers of the first layer and the plurality of chambers of the second layer align and overlap; and
a plurality of wells defined by the aligned the plurality of chambers of the first layer and the plurality of chambers of the second layer;
wherein each stem channel of the first layer and the second layer has a plurality of branch channels in direct fluid communication with each well;
wherein each branch channel of each layer is in direct fluid communication with a chamber of the each layer;
wherein each branch channel is disposed at an angle with respect to a respective stem channel and a respective chamber of the respective layer; and
wherein each well is in direct fluid communication with a respective branch channel of the first layer and a respective branch channel of the second layer.

2. The device of claim 1, wherein the first layer and the second layer are disposed so that the first set of inlets of the first layer are perpendicular to the second set of inlets of the second layer.

3. The device of claim 2, wherein the angle of each branch channel is about 30 to degrees.

4. The device of claim 3, wherein the angle is about 45 degrees.

5. The device of a claim 2, wherein:
the first set of inlets includes a first inlet and a second inlet; and
the second set of inlets includes a third inlet and a fourth inlet.

6. The device of claim 5, wherein each layer includes:
a network of inlet channels disposed between the respective set of inlets and the stem channels.

7. The device of claim 5, wherein:
each layer includes five stem channels; and
each network of inlet channels of each layer is in direct fluid communication with each stem channel.

8. The device of claim 7, wherein:
each network of inlet channels includes three generations of inlet channels.

9. The device of claim 8, wherein the inlet channels have a serpentine shape.

10. The device of claim 7, wherein:
the network of inlet channels of the first layer is configured to provide five different concentrations of a first agent provided via the first inlet and/or a second agent provided via the second inlet to the stem channels; and
the network of inlet channels of the second layer is configured to provide five different concentrations of a third agent provided via the third inlet and/or a fourth agent provided via the fourth inlet to the stem channels.

11. The device of claim 10, wherein:
wherein the device is configured to provide twenty-five different combinations and/or concentrations of four different agents.

12. The device of claim 2, wherein each layer includes:
a number of the plurality of chambers corresponds to a number of the plurality of branch channels; and
each branch channel of each layer is in direct fluid communication with a stem channel and a chamber.

13. The device of claim 12, wherein the plurality of branch channels for each stem channel having different dimensions.

14. The device of claim 13, wherein the plurality of branch channels for each stem channel has a different width.

15. The device of claim 2, wherein:
the plurality of branch channels for the each stem channel includes a first branch channel, a second branch channel, a third branch channel, a fourth branch channel, and a fifth branch channel;
the first branch channel is disposed near a first end of the each stem channel closest to the network of inlet channels and the fifth branch channel is disposed at the second end of the each stem channel.

16. The device of claim 15, wherein:
the first branch channel has a width w1;
the second branch channel has a width w2;
the third branch channel has a width w3;
the fourth branch channel has a width w4;
the fifth branch channel has a width w5; and
w1<w2<w3<w4<w5.
